(19) United States
(12) Patent Application Publication
(10) Pub. No.: US 2014/0297616 A1
(43) Pub. Date: Oct. 2, 2014

(54) SYSTEM AND METHOD FOR PROVISING ADVANCED JOB-TIME PLANNING AND SEARCH SERVICES FOR EMPLOYMENT SERVICES

(71) Applicant: Ge Zhao, Surrey (CA)

(72) Inventor: Ge Zhao, Surrey (CA)

(21) Appl. No.: 13/851,995

(22) Filed: Mar. 28, 2013

(51) Int. Cl. G06F 17/30

(52) U.S. Cl. CPC G06F 17/30867
USPC 707/708

(57) ABSTRACT

The present invention generally relates to computer and web-based methods for employment matching and search services. Specifically, this invention relates to systems and methods for allowing employers and potential employees to create and edit job-time plans and match jobs with one or more potential employees based on specific criteria, such as job-time plans, availability and workload with matching made across a plurality of candidates.

### FIELD OF THE INVENTION

The present invention generally relates to computer and web-based methods for employment matching and search services. Specifically, this invention relates to systems and methods for allowing employers and potential employees to create and edit job-time plans and match jobs with one or more potential employees based on specific criteria, such as job-time plans, availability and workload with matching made across a plurality of candidates.

### BACKGROUND

The search services provided by most present online job website at present are inaccurate and with limited coverage. Using job content or a resume as the scope for employment searching almost always leads to mistakes and inefficiencies. For example, if a potential employer wants to search for potential employees preferring a part time job, the potential employer searches resumes by using keyword “part time,” the search results always end up displaying part-time experience of listed potential employees. This is almost always due to the fact that searches are based on

Secondly, currently available systems fail to take into account the fact that actual work time of job is considered an important element of a job. Today, there are numerous jobs and employment opportunities with flexible start and end times jobs. Employees today frequently engage in more than one job, even where one of the jobs of an employee is a full time job.

For example, if a flexible full time job needs an employee to work five days a week, seven hours a day, the employee may be choose to begin working at 5 am and end work at noon. The remaining time of the day is enough to this employee to find a second job, even the second job is a full time but flexible job.

On the other hand, quality employees are always in short supply on the market. If an employer feels it is difficult to attract talented employees, the employer could take actions in order to attach talent, such as offering job with flexible work times, jobs with shortened work times, or part time jobs, to attract quality employees in the market for a second job. Therefore, knowing what time quality employees will become available on the market is very important.

In the part-time, contractor and temporary employment market, the factor of work time is important as it relates to the possibility of an employee performing a job or the possibility of an employer finding a quality employee. For example, when a housewife looks for a contractor to cut the lawn on Wednesday afternoon, she will need to know which contractor(s) will be available at that time because the work time and the available time of a lawnmower is fragmented and can be less predictable in the summer.

Therefore, there is a need in the art for a job search and fulfillment system and method that emphasizes the importance of work time with respect to primary and secondary employment markets and is configured to solve the problems of identifying and allocating employment resources as well as providing job-time planning and management services to the market.

Furthermore, the Internet gives people unprecedented opportunities for education and training Employees have already become more versatile through vocational training and are able to get additional knowledge and skill in a variety of industries and technological fields, whether online, in person or through some combination thereof. This makes it possible and probable for an employee trying a new career or engaging in multiple careers by working in multiple jobs in divergent industries or companies. For example, a music engineer in the software industry can also be a violin instructor in music teaching industry. The music engineer may look for a part time job of violin instructor and keep on doing his full time job of music engineer.

Therefore, there is a need in the art for a job search and fulfillment system and method that provides enhanced search methods to users, allowing the users to describe key points of a job or resume and explicitly search like keywords, thereby eliminating keyword ambiguity.

Therefore, there is also a need in the art for a job search and fulfillment system and method that provides a method to help potential employers and potential employees to manage job recruiting and/or job objectives by using job time planning systems which reveal available work times related to a job and availability of a job applicant.

These and other features and advantages of the present invention will be explained and will become obvious to one skilled in the art through the summary of the invention that follows.

### SUMMARY OF THE INVENTION

Accordingly, it is an aspect of the present invention to systems and methods for allowing employers and potential employees to create and edit job-time plans and match jobs with one or more potential employees based on specific criteria, such as job-time plans, availability and workload with matching made across a plurality of candidates.

According to an embodiment of the present invention, a computer implemented system for providing job-time planning includes: a planning management module comprising computer-executable code stored in non-volatile memory; a search engine module comprising computer-executable code stored in non-volatile memory; a process module comprising computer-executable code stored in non-volatile memory; a data store; a processor; and a communications module, wherein said planning management module, said search engine module, said process module, said data store, said processor, and said communications module are operably connected and are configured to: receive a request from a first user regarding job-time planning; identify an index-word package; identify search criteria; retrieve at least one index-word from an index-word database stored in said data store, wherein said at least one index-word was identified in said index-word package; process a job-time planning search based at least in part on said at least one index-word and said search criteria; and return results from said job-time planning search to said user via said communications module.

According to an embodiment of the present invention, the planning management module, said search engine module, said process module, said data store, said processor, and said communications module are further configured to generate a job-planning calendar from said results and return said job-planning calendar to said first user.

According to an embodiment of the present invention, the job-planning calendar comprises one or more jobs displayed on said job-planning calendar based on job-time and relevance to said first user.

According to an embodiment of the present invention, the results comprise one or more full-time jobs and criteria associated with said one or more full-time jobs.

According to an embodiment of the present invention, the planning management module, said search engine module, said process module, said data store, said processor, and said communications module are further configured to generate a set of part-time jobs based on said results.

According to an embodiment of the present invention, the set of part-time jobs is returned to said first user.

According to an embodiment of the present invention, the planning management module, said search engine module, said process module, said data store, said processor, and said communications module are further configured to generate an updated job-planning calendar based on said set of part-time jobs and return said updated job-planning calendar to said first user via said communications means.

According to an embodiment of the present invention, a computer implemented method for providing job-time planning, the method comprising the steps of: receiving a request from a first user regarding job-time planning via a communications module; identifying an index-word package via a planning management module; identifying search criteria via said planning management module; retrieving at least one index-word from an index-word database stored in a data store, wherein said at least one index-word was identified in said index-word package; processing, at a process module, a job-time planning search based at least in part on said at least one index-word and said search criteria; and returning, via said communications module, results from said job-time planning search to said user.

According to an embodiment of the present invention, the method includes step of generating a set of part-time jobs based on said results.

According to an embodiment of the present invention, the method includes the step of generating an updated job-planning calendar based on said set of part-time jobs and returning said updated job-planning calendar to said first user via said communications means.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a network schematic of a job-time planning system, in accordance with an embodiment of the present invention;

FIG. 2A is a schematic of an exemplary embodiment of a job-time planning system, in accordance with an embodiment of the present invention;

FIG. 2B is a schematic of a portion of an exemplary embodiment of a job-time planning system in accordance with an embodiment of the present invention;

FIG. 2C is a schematic of an exemplary embodiment of a search engine component in accordance with an embodiment of the present invention;

FIG. 3 is a flowchart of an exemplary signup method, in accordance with an embodiment of the present invention;

FIG. 4 is a flowchart of an exemplary method for a job-time planning system, in accordance with an embodiment of the present invention;

FIG. 5A is a flowchart of an exemplary method for a job-time planning system, in accordance with an embodiment of the present invention;

FIG. 5B is a flowchart of an exemplary method for a job-time planning system, in accordance with an embodiment of the present invention;

FIG. 5C is a flowchart of an exemplary method for a job-time planning system, in accordance with an embodiment of the present invention;

FIG. 5D is a flowchart of an exemplary method for a job-time planning system, in accordance with an embodiment of the present invention;

FIGS. 6A-6B are illustrations of a graphical user interface for a job-time planning system, in accordance with an embodiment of the present invention;

FIGS. 7A-7C are illustrations of a graphical user interface for a job-time planning system, in accordance with an embodiment of the present invention;

FIGS. 8A-8E are illustrations of a graphical user interface for a job-time planning system, in accordance with an embodiment of the present invention;

FIGS. 9A-9C are illustrations of a graphical user interface for a job-time planning system, in accordance with an embodiment of the present invention; and

FIGS. 10A-10B are illustrations of a graphical user interface for a job-time planning system, in accordance with an embodiment of the present invention.

### DETAILED SPECIFICATION

The present invention generally relates to computer and web-based methods for employment matching and search services. Specifically, this invention relates to systems and methods for allowing employers and potential employees to create and edit job-time plans and match jobs with one or more potential employees based on specific criteria, such as job-time plans, availability and workload with matching made across a plurality of candidates.

According to an embodiment of the present invention, the systems and methods are accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory, cloud storage). Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however a user may be able to compose data offline that will be consumed by the system when the user is later connected to a network.

According to an embodiment of the present invention, one aspect of the job-time planning system is to provide users (e.g., potential employers and potential employees) with enhanced job and job-time searching services. These enhanced job and job-time searching services utilize index-word search criteria as well as data about one or more user's job-time planning calendar (described in detail below).

In accordance with a preferred embodiment of the present invention, index-words are a plurality of standardized words which describe key points of a job or a resume and can be used for explicitly searching like keywords and will not lead to ambiguity as natural language keywords do. In utilization, prior to posting a job, a potential employer is required by the system to: (1) Create a profile containing information about the employer (e.g., name, address, type of employer); (2) provide one or more index-words about a job by filling a job information page; and (3) set the work time of the job required which will generate a job-time planning calendar.

According to an embodiment of the present invention, prior to posting a resume, a potential employee is required by system to: (1) Create a profile where contains information about the employee (e.g., name, address, phone number); (2) provide information about the job or jobs the potential employee presently engaged in by filling a job information page, including the work time of the job or jobs which will generate a job-time planning calendar; (3) set each type of job which the potential employee is willing to accept by filling out one or more job information pages, Job information pages are comprised of a plurality of data points, which may include, but are not limited to: whether the job is a full-time, part-time, flex-time, contractor job, internship, seasonal or temporary job; whether the job is in a different industry or category from the jobs the employee currently has; index words associated with the job; available work times (e.g., for the job, for the current employment of an employee, for the hours the potential employee is seeking work); resumes associated with the user; or any combination thereof. Each job will generate an objective calendar which reveals the available work time for this kind of job.

For an example of the above described search system, imagine a user who has a job as a realtor but also has qualifications as an accountant. When the real estate market collapses, the realtor may looks for either a full time job as an accountant in the finance industry or a part time job as a realtor in real estate industry. Then, the user would set both (i) a full time job objective for the finance industry and (ii) a part time job objective for the real estate industry.

According to an embodiment of the present invention, a data store component of the system comprises one or more of a profile database, a job/resume database, an index-word database and a calendar database. In preferred embodiments, the system provides search services in conjunction with the data stored within the various databases in the data store. In one preferred embodiment, search services are utilized in particular with the index-word database and the calendar database.

In an example of a utilization of search services limited to the index-word database and calendar database, in accordance with the present invention, a potential employer or a potential employee could reach the resume content or job content through relevant links but would not be able to perform a search on resume content or job content. In one preferred method of job-time planning and enhanced search provided by the system, a potential employer may be provided the following advantages of previous search systems: (i) a potential employer may be provided statistical and specific information related to available qualified potential employees; (ii) a potential employer may be provided information about what quality employees are looking for in an ideal job (e.g., salary, benefits, flexibility, work-life balance); (iii) a potential employer may be provided the ability to model potential changes in the employment market (e.g., increase/decrease in labor force, increase/decrease in qualified candidates for jobs) and provided information related to those potential changes (e.g., increased/decreased wage/benefit expectations); (iv) providing employment recommendations based on information stored in one or more of the database (e.g., transfer job from full-time to part-time, increase/decrease proportion of employees of a given type, determining availability of quality employee available expanded positions/openings); (v) determine common work times for one or more employees (e.g., for employment requiring a group of employees to work at the same time); and (vi) determine disparate work times for one or more employees (e.g., for employment requiring employees present at all times, such as shift work); determine common work times shared by employers and employees (e.g., a builder wants to hire a plurality of workers to renew a roof and a shared work time with the workers is required so the builder can oversee the project). These and other advantages will be discussed throughout the present disclosure.

According to an embodiment of the present invention, the system may be further configured to break down jobs into various sub-components or sub-jobs. For instance, a roofing job could be broken down into the various aspects of the job (e.g., removing old shingle, sealing and/or repairing roof base material, placing new shingle) and each aspect can be recruited for and scheduled accordingly. In the previous example, it may be noted that the job can only be done during certain hours of the day in order not to disturb the residents and that certain job components must happen in specific order (e.g., must remove the shingle before repairing the roof base material). In this manner, the system can not only identify appropriate potential employees, but the system can recruit based on specific needs (e.g., a lesser skill is required in removing shingle as opposed to placing new shingle), time requirements and order requirements.

Further, embodiments of the system can be configured to identify recruiting needs for various components of the job. Continuing on the example above, if the employer can only recruit 50% of the maximum need for one job component (e.g., removing shingle), then the system can generate estimates on how many fewer recruits it should hire for other job components (e.g., not as many base material repairers are needed as a full complement would move faster than the shingle removers could work leaving underutilized repairers).

According to an embodiment of the present invention, the system can also be configured to break down full-time jobs into a plurality of part-time jobs if there are better or more aptly skilled/trained/educated/affordable potential employees. Likewise, the system can be configured to combine multiple part-time jobs if the system identifies matches for a potential employee that matches all (or a substantial majority of) the combined part-time job requirements.

According to an embodiment of the present invention, through use of the systems and methods described herein, a potential employee is provided enhanced planning abilities with respect to job type and work time. Characteristics of a given job (e.g., objective, requirements, work time, pay, benefits) differ based on the type of job and the characteristics potential employees seeks varies based on the type of job and on the employment market. For example, an employee may desire salary plus some benefits for a full time job but would understand receiving only an hour pay rate for a part time, a contractor or a temp job. In another example, if a potential employee has a full time job with work time from Sam to 3 pm, the potential employee may seek a better paid full time job and set the work time range from Sam to 8 pm. At the same time, the potential employee may seek a part time job on the market, but only set the work time range from 4 pm to 8 pm. Embodiments of the present invention allow employees to classify job objectives and job-time planning into different types which the system utilizes to identify and match potential employment opportunities. For instance, the system can identify a combination of part-time and/or full-time positions that would offer better characteristics (e.g., pay, benefits, work time) than an employee's present job(s). The system can also be configured to provide alerts to an employee when new jobs and/or job combinations become available that would be more advantageous to the employee.

According to an embodiment of the present invention, the system may also provide a potential employers statistical or actual data related to other employers in the market (e.g., number of jobs open in the field, number of jobs open in the area, average pay, average experience, average time employees spent looking for jobs prior to gaining a position). In this manner, employers may make decisions based on information related to their industry, size, type and other characteristics important to them as an employer and to their employees or potential employees.

According to an embodiment of the present invention, the system allows employees to classify time (e.g., on calendar through information stored in the calendar database) into various statuses (e.g., available, not available, desired hourly rate for specified times, available only for full-time work, available only for part-time work). In this manner, a potential employee is able to tell potential employers when the potential employee will be available and under what conditions the potential employee is available (e.g., part-time, full-time, pay rate, benefits, travel expenses required). This is particularly useful in the part time, contractor or temp job market, where the available time of a potential employee is fragmented and requirements vary more widely from employee to employee.

According to an embodiment of the present invention, the system provides methods for assisting potential employees in making decisions on employment markets based on analysis of statistical data generated by and stored in the data store (and in some embodiments, data generated during searches). For example, a potential employee may be alerted to a marked increase in potential jobs from potential employers in the potential employee's field and suggest increasing salary demands based on criteria available to the system (e.g., shortages in supply of qualified potential employees in the field, increase in salary demands by other similarly situated potential employees, increase in salary paid to employees accepting jobs with the potential employers).

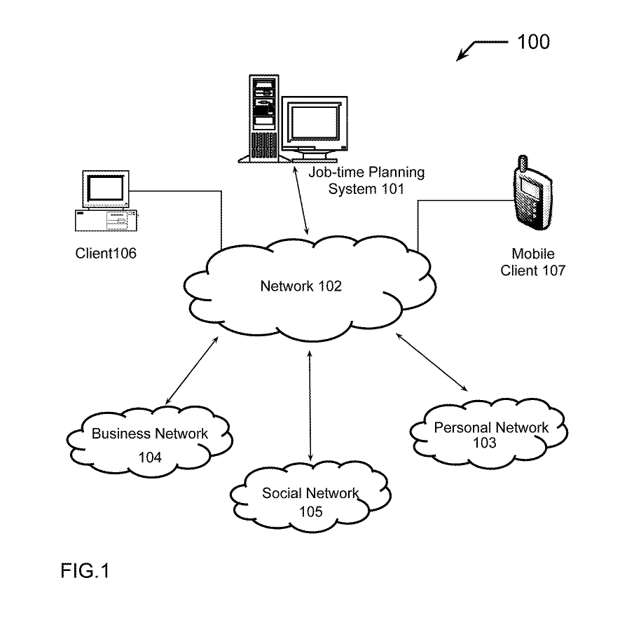

Turning now to FIG. 1, an illustration of an exemplary networked system is shown. As illustrated, this exemplary job-time planning system 101 is interconnected through networks/internet 102 to one or more client devices 106, mobile clients 107, and third party networks (e.g., business network 104, social network 105, personal network 103). Embodiments of the present invention may be accomplished through fewer or additional components, and embodiments of the present invention are contemplated for use with any number of the above referenced components.

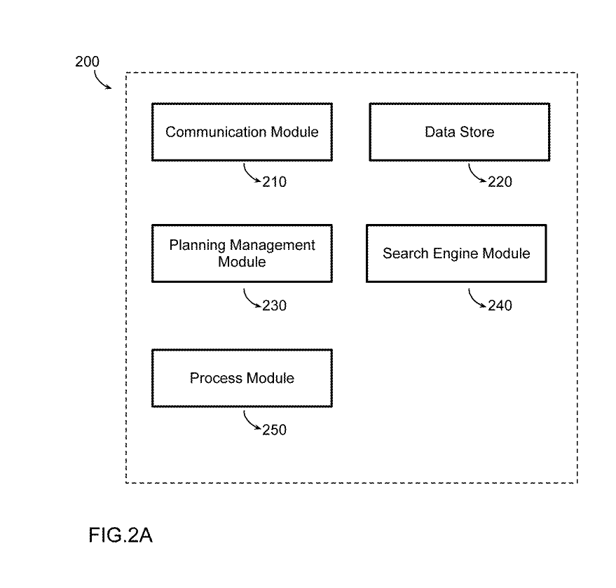

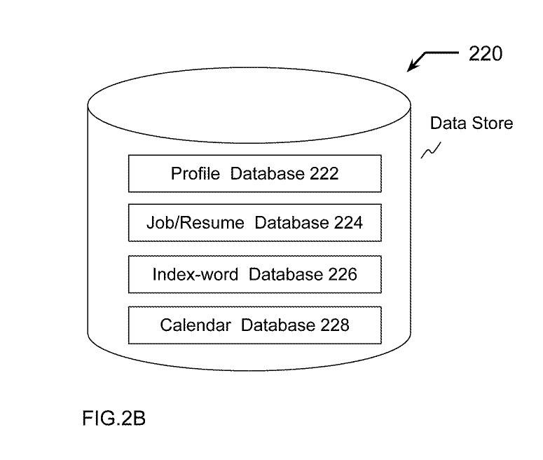

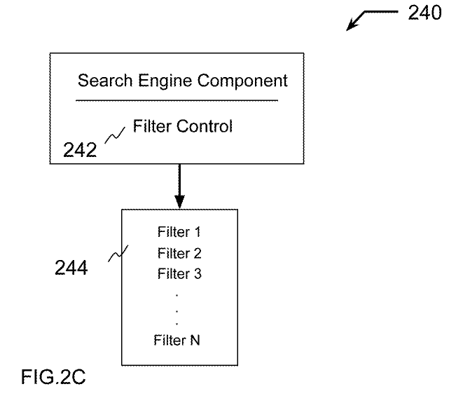

In FIG. 1, various client devices 106 are connected to the job-time planning system 101 via one or more networks 102. In certain embodiments, job-time planning system 101 could be a standalone server providing job-time planning services across one or more networks to users and accessing data from one or more remote service network servers via an application programming interface (API) or other interface with such service network servers. Job-time planning system 101 is described in more detail below in conjunction with FIG. 2A.

Turning now to FIGS. 2A, 2B and 2C, illustrations of exemplary computer system architectures suitable for utilizing and/or providing job-time planning services are provided. FIG. 2A outlines an exemplary embodiment of a programmed computer system for providing a job-time planning service, comprising a communications module 210, data store 220, planning management module 230, search engine module 240 and a processing module 250. Each of the aforementioned components and modules being communicatively connected to one another, either directly or through the other components or modules or other intervening hardware or software component.

According to an embodiment of the present invention, a communications module 210 may be integrated into the system or communicatively connected to the system and configured to handle the transmission and receipt of data and communications between the system, user, client devices, networks, service networks or any combination thereof. Communications modules 210 include, but are not limited to Ethernet or other wired communications routers/switches/cards, wireless routers/switches/cards, fiber optic communications devices, cellular communications devices, or any combination thereof. One of ordinary skill in the art would appreciate that there are numerous types of communications modules 210 that could be utilized with embodiments of the present invention, and embodiments of the present invention are contemplated for use with any type of communications means.

According to an embodiment of the present invention, a data store 220 is provided to store relevant data associated with the system, users and other important information associated with the methods provided. As shown in FIG. 2B, a data store 220 may include one or more of a profile database 222, job/resume database 224, index-word database 226 and a calendar database 228. One of ordinary skill in the art would appreciate that these databases may exist in a single database or across multiple databases communicatively connected to one another and that these databases may exist on a single computing device or stored across multiple computing devices in a distributed manner.

According to an embodiment of the present invention, the search engine module 240 may be configured to (i) execute search tasks assigned by planning management module 230 or process module 250, (ii) search data in one or more databases (e.g., profile database, job/resume database, index-word database, calendar database), and (iii) return search results to planning management module 230, processing module 250 or communications module 210. The search engine module 240 may also be configured to implement a plurality of selectable filters to filter at least a portion of the search results.

According to an embodiment of the present invention, the planning management module 230 is configured to generate and provide job-time and search functionality to users connected to the system through the communications module 210. Much of the functionality provided by the present system originates or occurs in the planning management module 230. It is here that the system initiates or generates (whether originating here or upon request of a user) matches and search results for job-time searches and employment matching services.

According to an embodiment of the present invention, the search engine module effects search requests received from the process module 250 or the planning management module 230. The search engine module is comprised of components configured to receive requests from the aforementioned components and process those requests into data sorting and searching means in conjunction with data stored in the data store 220.

Turning now to FIG. 2C, an Illustration showing the architecture of search engine is shown. The architecture of search engine module 240 shown in FIG. 2C illustrates components comprising a plurality of filters 244 through a filter control 242 used to at least filter out a portion of data retrieved from one or more of the databases (e.g., profile database, job/resume database, index-word database, calendar database). Filtering can be done on any data type or portion of information (e.g., name, job-time, job-type, employer type, employee type). One of ordinary skill in the art would appreciate that there are numerous types of filters that could be utilized with embodiments of the present invention, and embodiments of the present invention are contemplated for use with any type of filter.

According to an embodiment of the present invention, the process module 250 handles most of the actual processing of requests and other data driven processes. In a preferred embodiment, the process module 250 comprises a combination of one or more components selected from the group comprising memory, CPU, storage mediums and software or computer code capable of directing the other components to perform the functions described in the present application.

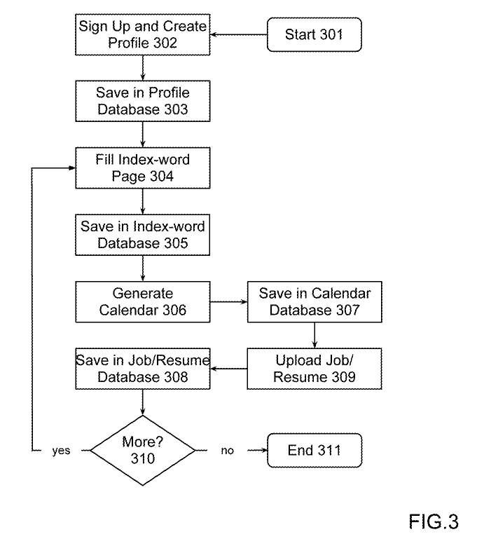

Turning now to FIG. 3, an illustration of a flow diagram generally showing an exemplary embodiment of a method for a new user to upload a job or a resume to the system. The method starts at step 301 with a user connecting to the system via a communications means. At step 302, the user (entity or person) signs up for the system and creates a profile which contains some basic information about the user. The profile information is saved (preferably automatically upon submission) and stored in the profile database within the data store 220 at step 303.

At step 304, the user fills the job information page with the index-word about job or job objective. Those standardized index-words will be saved and stored in an index-word database at step 305. The index-word is stored in a manner directed by the user and can be utilized as a part of the search criteria used when the user performs a job search. The set of index-words describing a job or a job objective is defined as an “index-word package.”

At step 306, the user fills out a job-time information page submits the job-time information to the system. The system then generates a job-time calendar according to user's input. The data associated with the calendar is saved and stored in the calendar database at step 307.

At step 308, the user is provided the ability to upload a job or a resume associated with the index-word(s) provided by the user. The system will then save and store the job or resume the in Job/Resume database at step 309. If the user wants to upload more jobs or resumes at step 310, the system will loop through the process from step 304 to step 309. Otherwise, the process proceeds to step 311 and will end there.

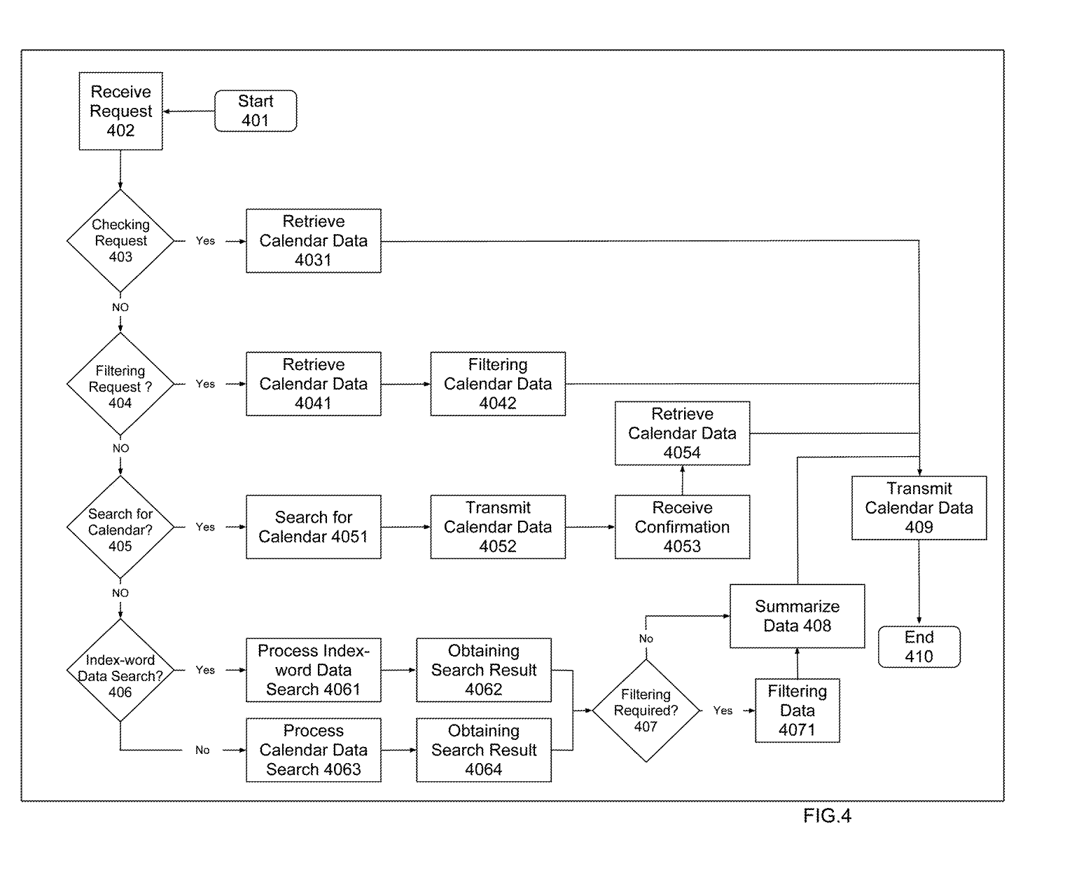

Turning now to FIG. 4, a logical flow diagram generally showing one embodiment of a process for a request from a user is shown. The method starts at step 401. At step 402, the system receives a request from a user. At step 403, the system checks to see if the request is related to reviewing a job-time calendar. If so, the system retrieves the data of calendar at step 4031, transmits the calendar information to the user at step 409 and the process ends at step 410.

If the request is not a request to check a job-time calendar, the system proceeds to check if the request is a filtering request at step 404. If the request is a filtering request, the system (i) retrieves the relevant data of calendars at step 4041; (ii) filters the data among the calendars at step 4042 based on criteria identified in the request from the user; and (iii) transmits the calendar data to the user at step 409. The process then ends at step 410.

If the request is not a filtering request, the system checks to see if the request is a request to search a calendar. If so, the system proceeds to search the calendar data store for the name of a person or an entity at step 4051. At step 4052, the system transmits the name data to the user for verification. The user then verifies the name at step 4053 and the system proceeds to retrieve the calendar data at step 4054. At step 409, the system transmits the data to user and the process ends at step 410.

If the request is not a calendar search, the system checks to see if the request is an index-word data search (step 406). If so, the process proceeds to step 4061 and processes the index-word data search and obtain the search result (step 4062). If it is not, the system processes the request as a calendar data search, processes the relevant calendar data search (step 4063) and obtains the search result (step 4064).

In either of these flows, the system then checks to see if filtering of the data provided is required (step 407). If no filtering is required, the process goes to step 408. Otherwise, the system will filter the profile search result with the calendar search result at step 4071. At step 408, the system summarizes the search result and transmits the data to user at step 409. The process then ends at step 410.

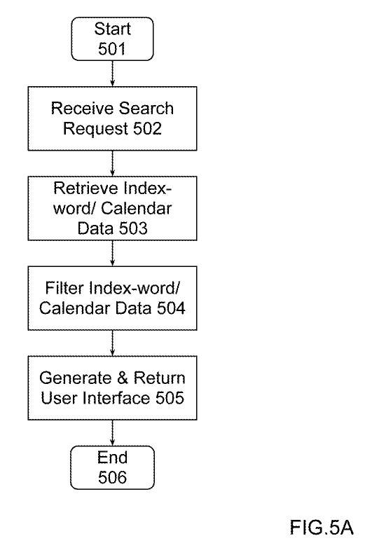

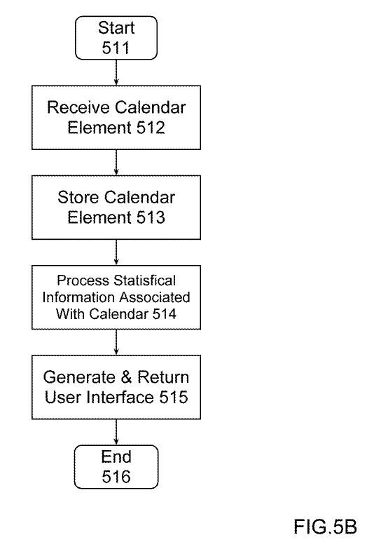

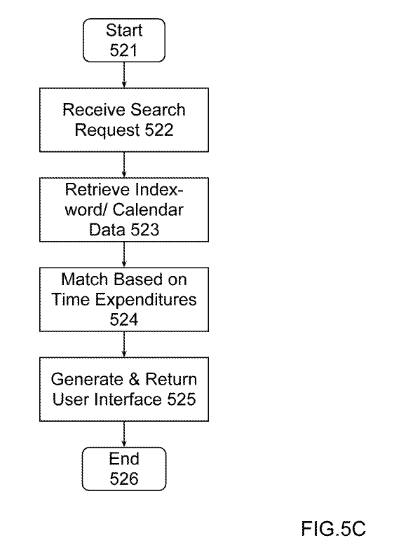

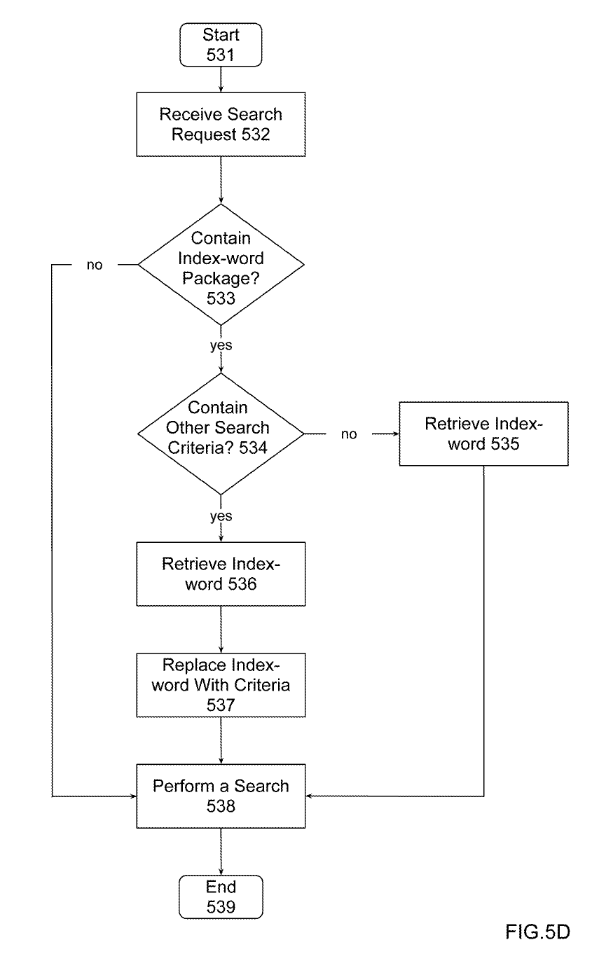

Turning now to FIG. 5A, an exemplary process flow for advanced job-time planning search is shown. The process starts at step 501 with a contact being received from a user. At step 502, the system processes the contact request which has been identified by the system as a search request. At step 503, the system retrieves relevant index-word and calendar data from index-word database and/or calendar database. Index-word data and calendar data may be retrieved which references one or more users, depending on the number of calendars involved in the search.

At step 504, the system filters the retrieved index-word and calendar data based on filtering parameters received from the user in the request. A subset of all index-word elements and calendar elements may be constructed from this filtering.

At step 505, the system generates and returns an appropriately formatted user interface or relevant data package from the subset of index-word elements and calendar elements generated during the filtering step. This provides the user with a formatted calendar or calendar data set based upon the calendars, index-word and filters identified by the user in previous steps. At step 506, the process terminates.

Turning now to FIG. 5B, an exemplary process flow for storing calendar elements and generating statistical information related to calendar elements as enabled by the system is shown. The process starts at step 511 with contact being received from a user; in this case the contact is for the insertion of one or more calendar elements into one or more user's calendars. At step 512, the system processes the contact into a calendar element submission request. Prior to processing the request, the system may be configured to authenticate one or more security protocols and logins (multiple security protocols and logins may be required if the calendar element is to be processed for multiple users at the same time).

At step 513, the system has validated the user(s) and processed the request for inserting the calendar element into the calendars of one or more users. At this step, the system also stores information related to the calendar event into the relevant data stores, which may include updated index-word information, updated calendar information or any combination thereof.

At step 514, the system processes statistical information about the calendar element for the users associated with the element. This may include, but is not limited to, processing statistical information regarding the type of job, the work time associated with the job, the industry and category of the job, the salary/wage level of the job and affiliated associations amongst various users where matching is based on statistical time utilization amongst users.

At step 515, the system generates and returns an appropriately formatted user interface or relevant data package as updated by the generation of the statistical information in step 514. In certain embodiments, this may provide the user with a formatted calendar or calendar data set based upon the index-word calendars and filters identified by the user in previous steps. At step 516, the process terminates.

Turning now to FIG. 5C, an exemplary process flow for matching users based on time expenditures is shown. The process starts at step 521 with contact being received from a user; in this case the contact is for the matching of the user with one or more other users based on one or more criteria. At step 522, the system processes the contact into a calendar matching request. Prior to processing the request, the system may be configured to authenticate one or more security protocols and logins (such as verifying the user has access to matching index-word or identifying appropriate publicly available index-word data for matching).

At step 523, the system has validated the user and processed the matching request criteria. Criteria for the matching request may be standard matching (e.g., match 2 or more users with similar time expenditures, available time matches, or other common matching components). In the alternative, criteria may be selected to allow users to identify matches with one or more individuals that are not similar to themselves (e.g., a user may wish to be matched with objective wage rate under a certain level). In any event, once the criteria have been established, the system retrieves index-word and calendar data for appropriate potential matches.

At step 524, the system processes matches based on the criteria provided and the information retrieved from the index-word and calendar data stores. Matches may be weighted based on the importance or relevance of certain criteria. The system can be further configured to require a match to be greater than a certain threshold before considering a potential match an actual match (e.g., the potential match meets at least 50% of the criteria identified in the request).

At step 525, the system generates and returns an appropriately formatted user interface or relevant data package containing the one or more matched results identified in step 524. In certain embodiments, this may provide the user with a formatted calendar or calendar data set based upon the index-word, calendars and/or filters identified by the user in previous steps. At step 526, the process terminates.

FIG. 5D is an exemplary process flow for replacing the criteria in the index-word package with the new criteria which user has submitted. The process starts at step 521 with search request being received from a user. At step 522, the system check if there is an index-word package contained in the request. If no, the system proceeds to perform a search at step 538 and the process ends at step 539.

Otherwise, the system will check if there is other criterion contained in the request at step 534. If no, the system proceeds to retrieve index-word stored in database at step 535. At step 538 the system performs a search according to the criteria of index-word and the process ends at step 539. If the decision step 534 is not satisfied, the system proceeds to retrieve index-word(s) stored in the database at step 536.

At step 537, the system compares the criteria with the index-word(s). If the same type of criteria occurs between the index-word and criteria, the former will be replaced by later. At step 538, system proceeds to perform a search and the process ends at step 539.

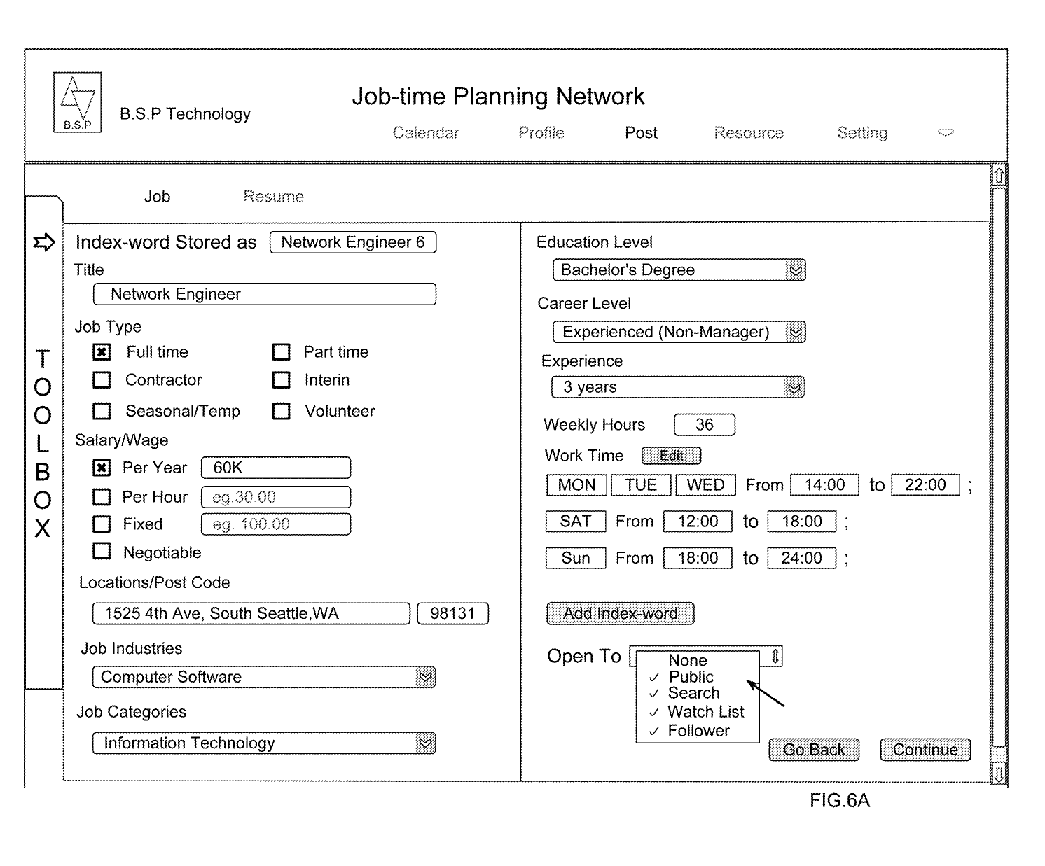

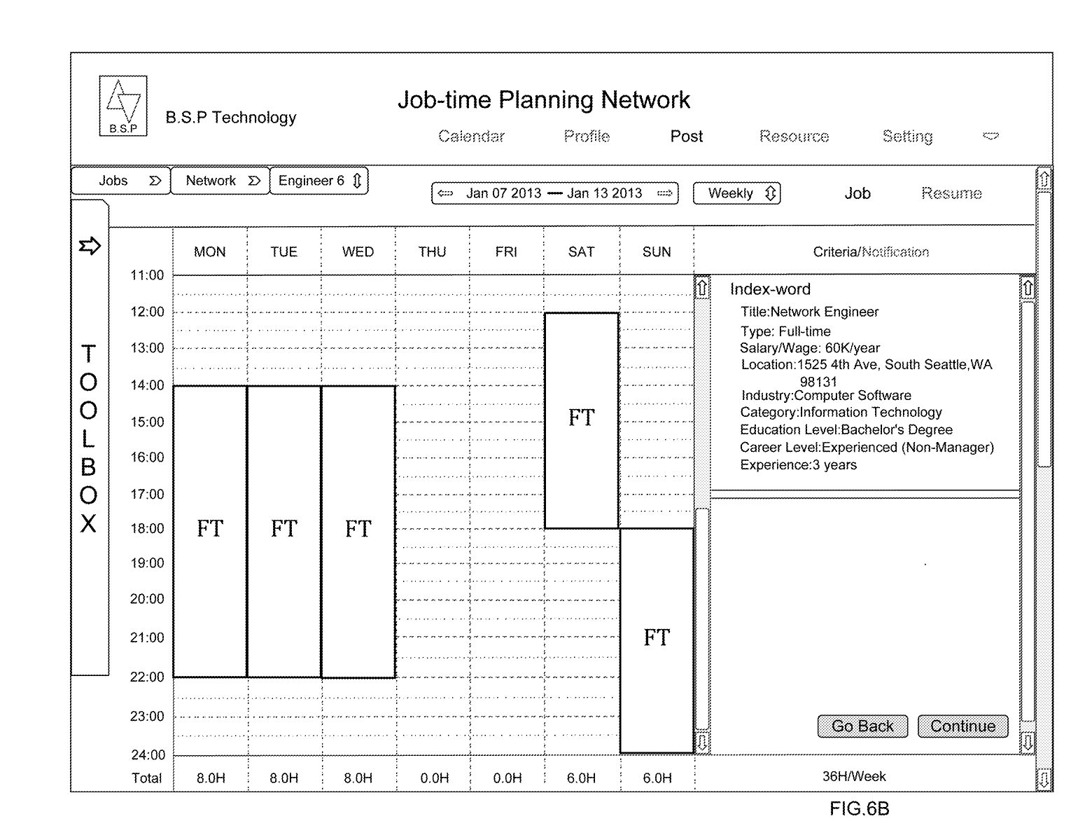

Turning now to FIG. 6A, an exemplary user interface showing a potential employer filling an index-word information page is shown. FIG. 6B is an exemplary user interface showing a job-time planning calendar generated by the index-word inputted in previous FIG. 6A.

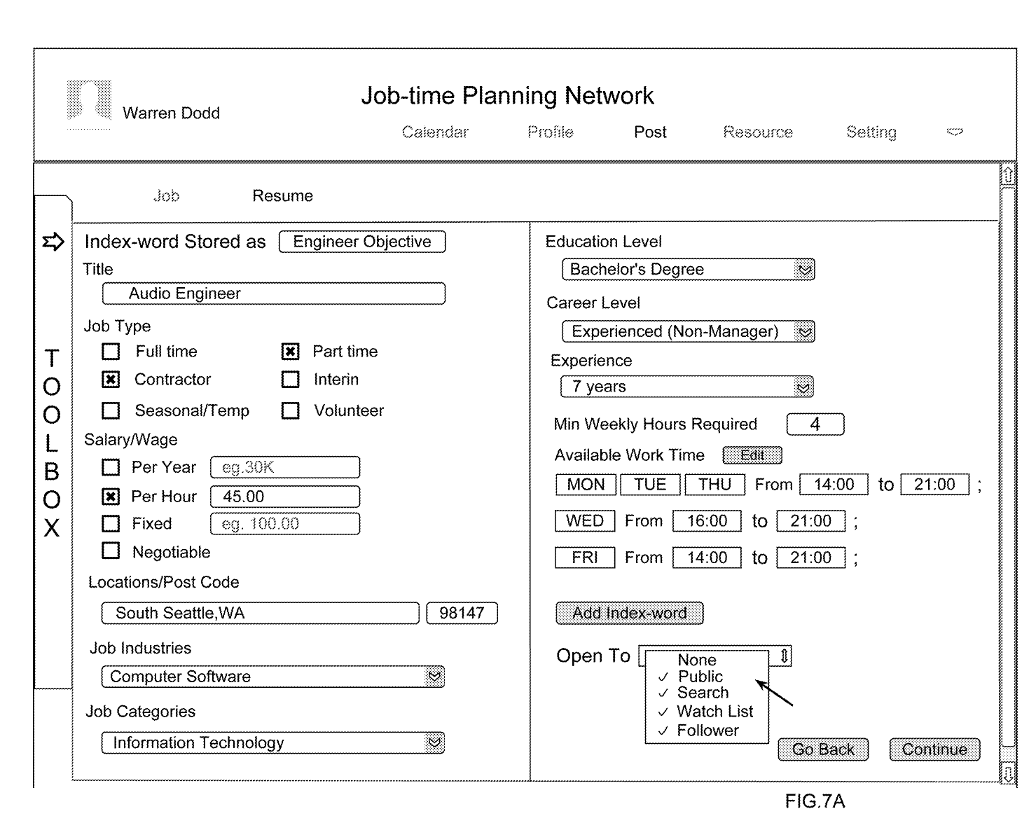

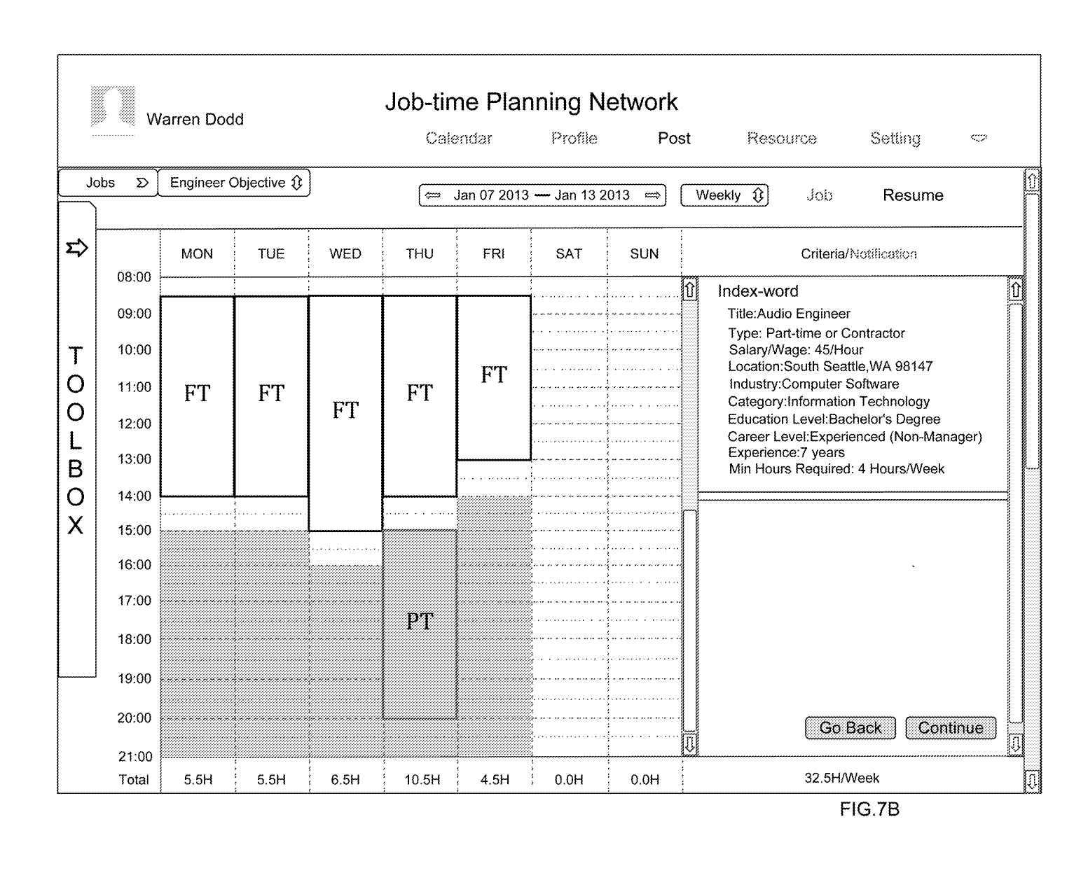

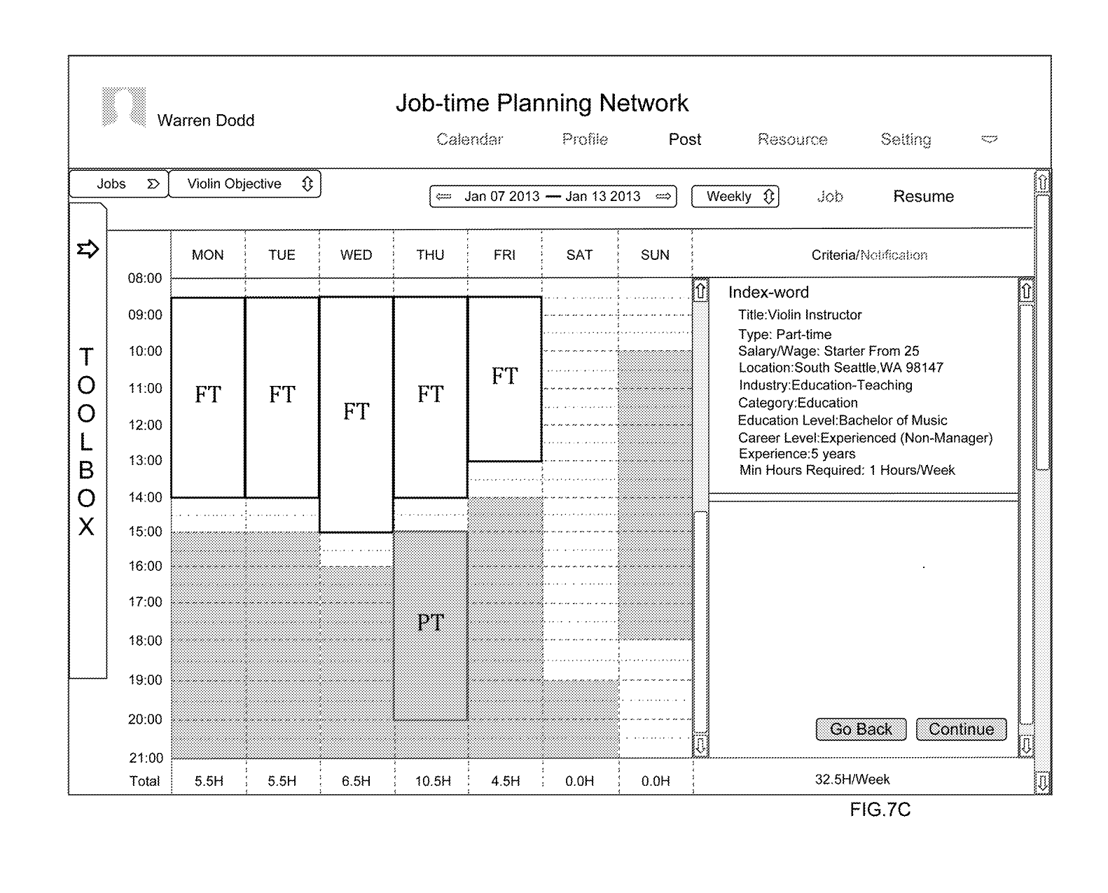

Turning now to FIG. 7A, an exemplary user interface showing a potential employee filling an index-word information page is shown. FIG. 7B is an exemplary user interface showing a job-time planning calendar generated by the index-word inputted in previous FIG. 7A.

FIG. 7C is a job-time planning calendar generated by another set of index-word(s). It should be apparent that there are a lot of different index-word(s) utilized between FIG. 7B and FIG. 7C. Here, the objectives for different jobs are different even if it is set by a same potential employee.

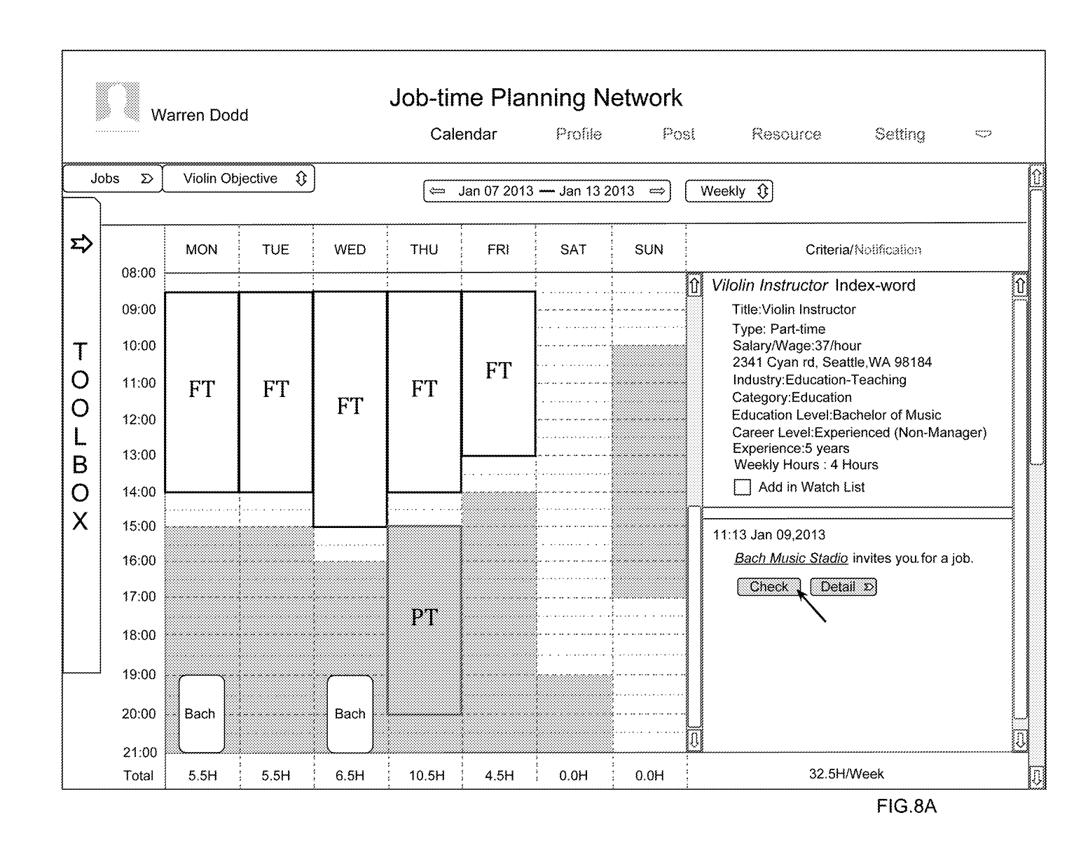

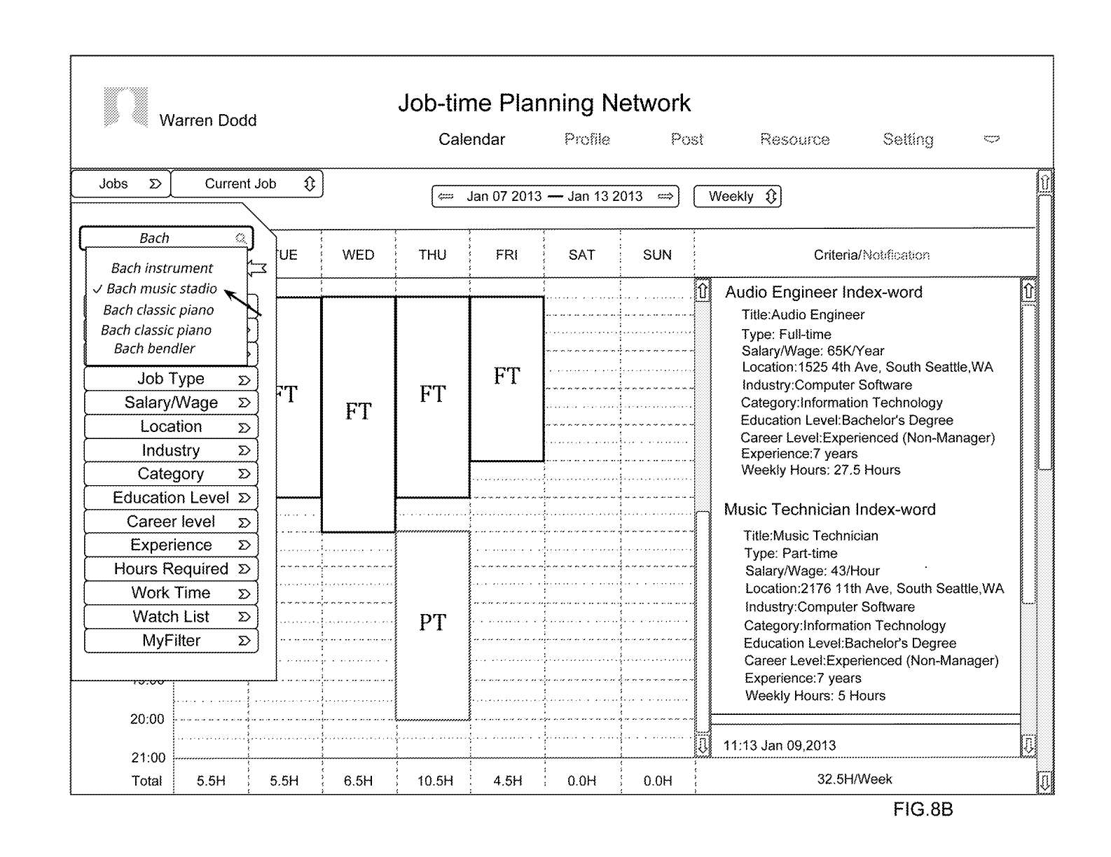

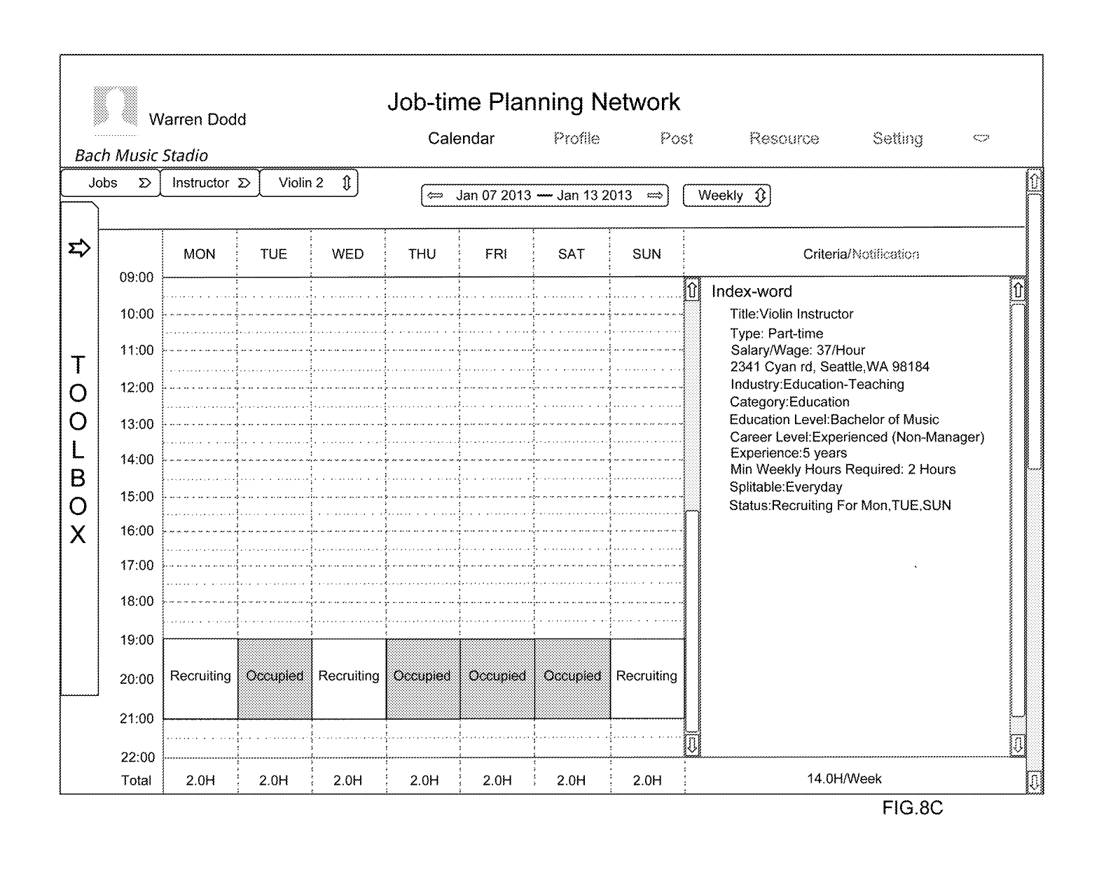

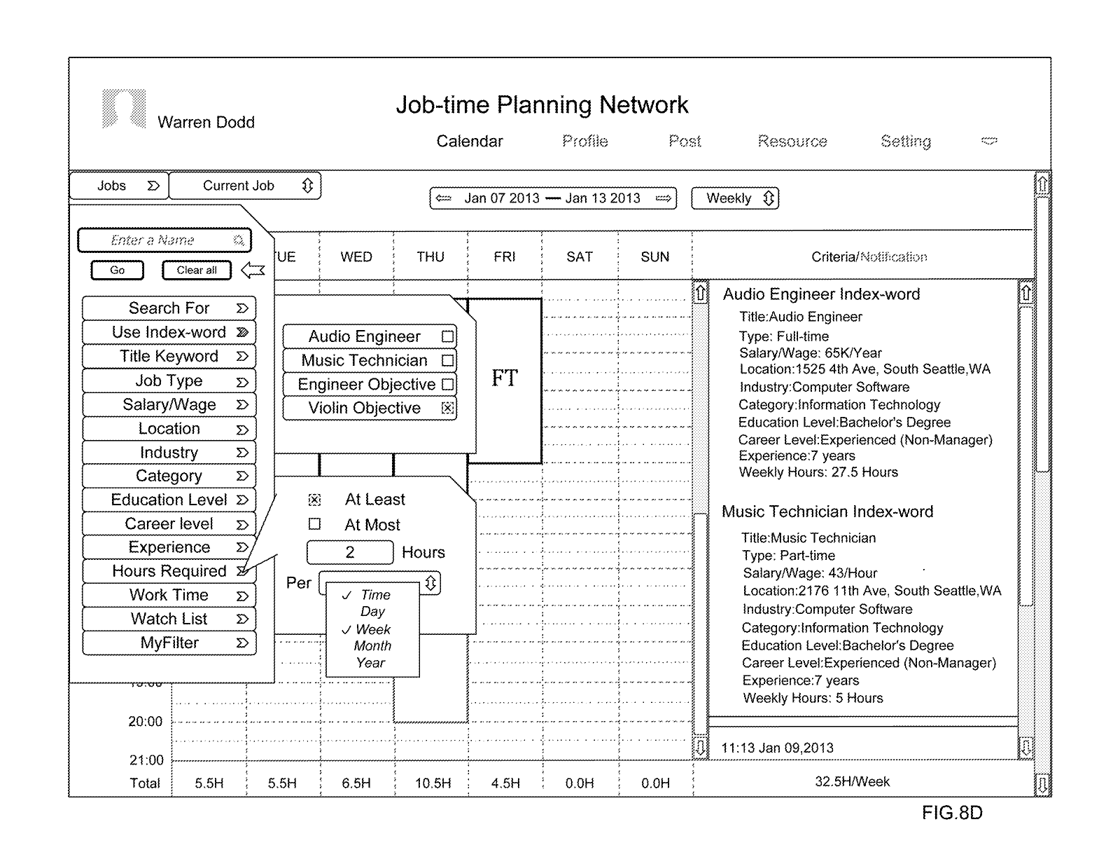

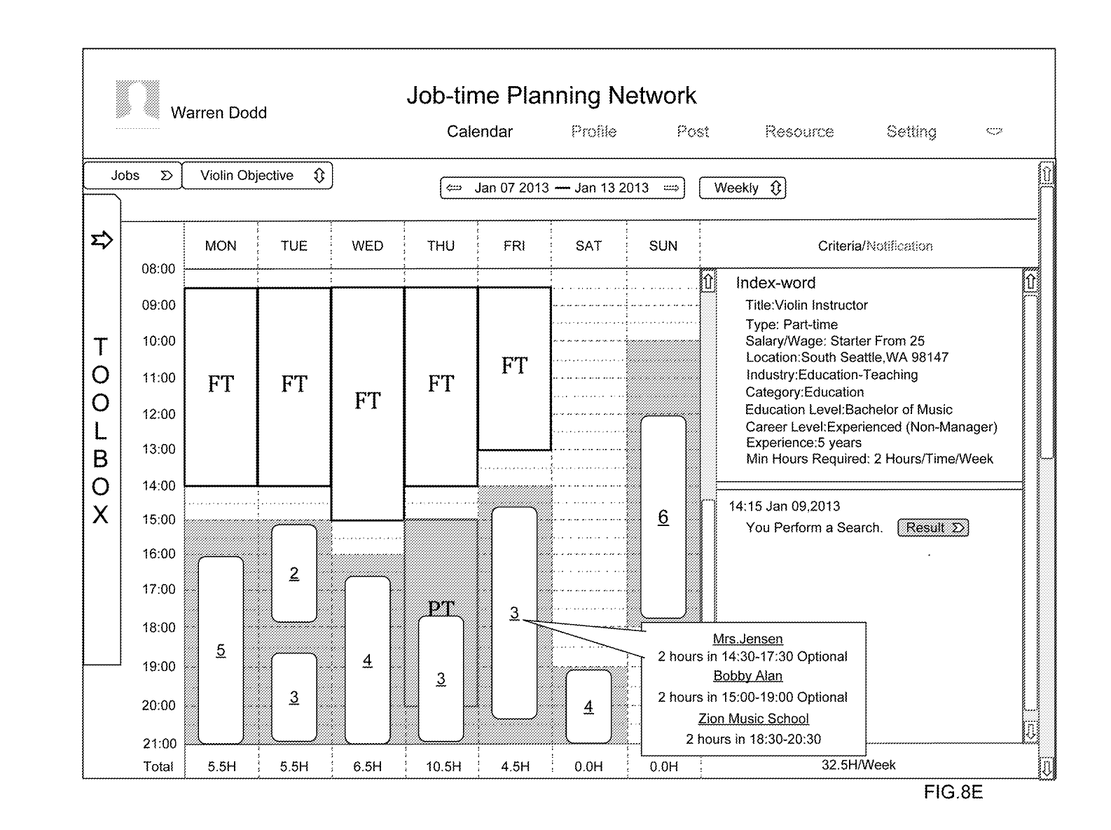

Turning now to FIGS. 8A-8E, various exemplary user interfaces in accordance with embodiments of the present invention are shown. In FIG. 8A, a potential employee checks an invitation from a potential employer. The relevant index-word is shown in the Criteria/Notification area and the work time is displayed on the calendar interface. In FIG. 8B, a potential employee performs a search for a calendar which is stored in the name of a person or an entity with the database. In FIG. 8C, the calendar shows the index-word and work time of a job, and the occupancy status of the job.

In FIG. 8D, a potential employee performs an advanced search. The search criterion contains an index-word package which is mentioned in FIG. 5D. In FIG. 8E, the search results (statistical figures) are displayed on the calendar interface.

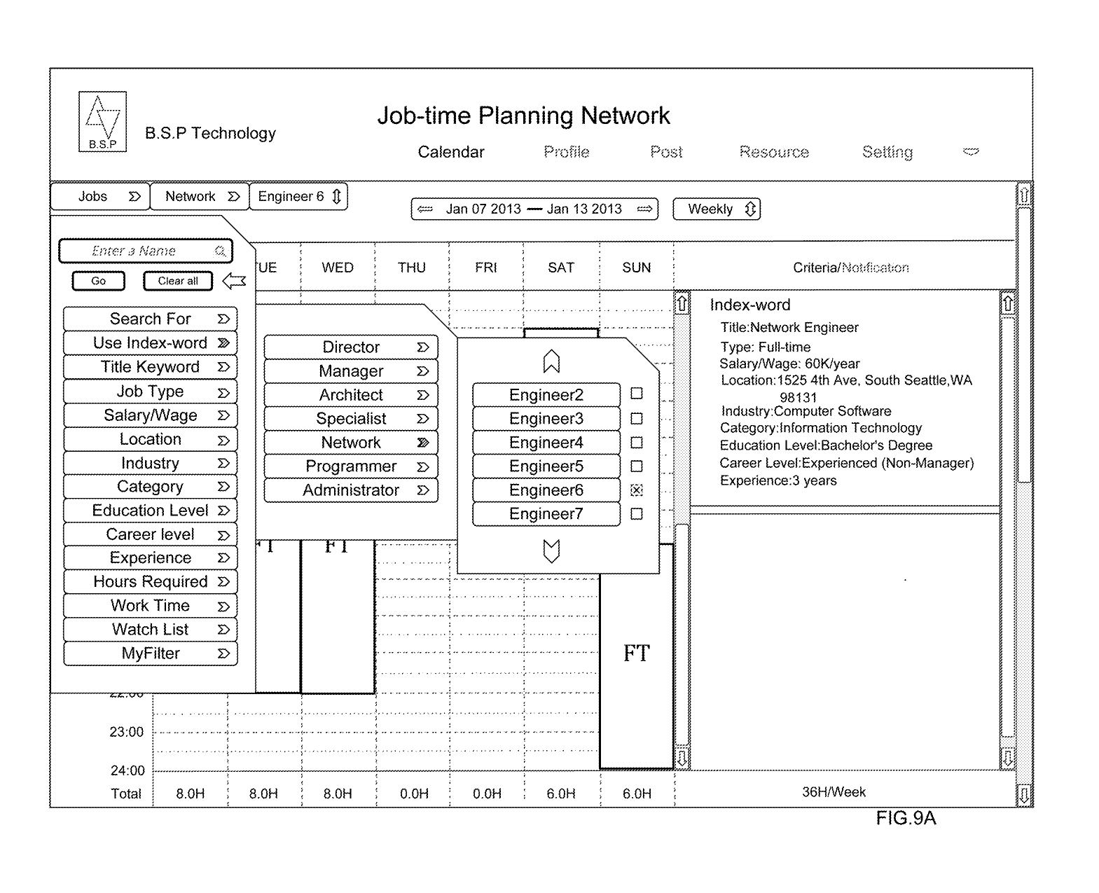

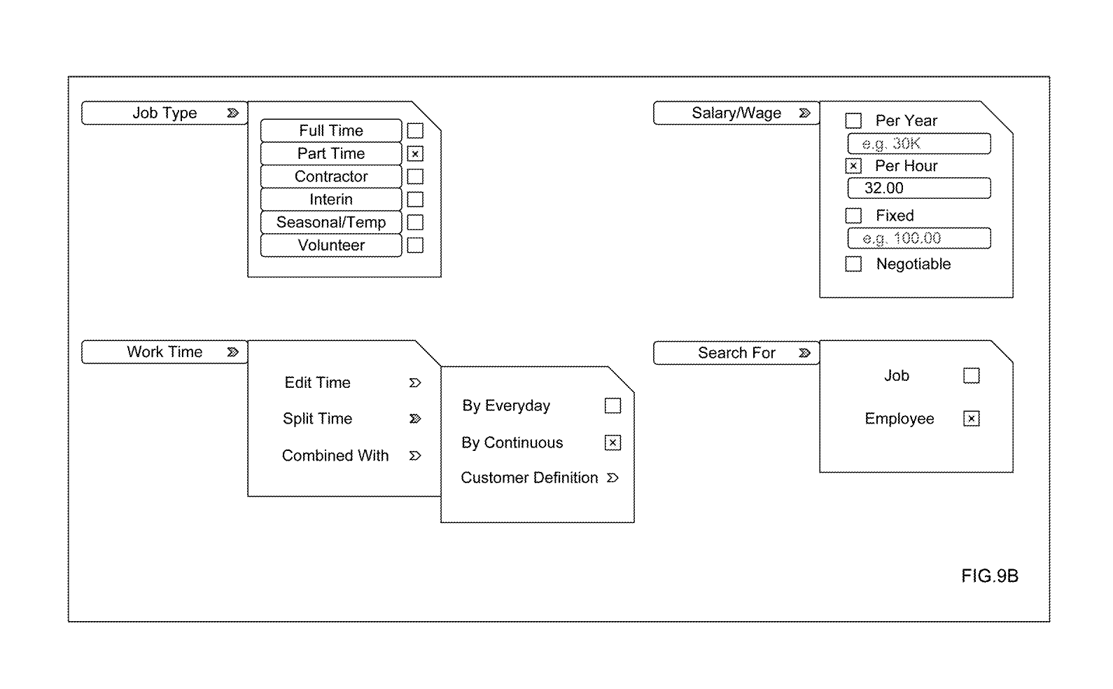

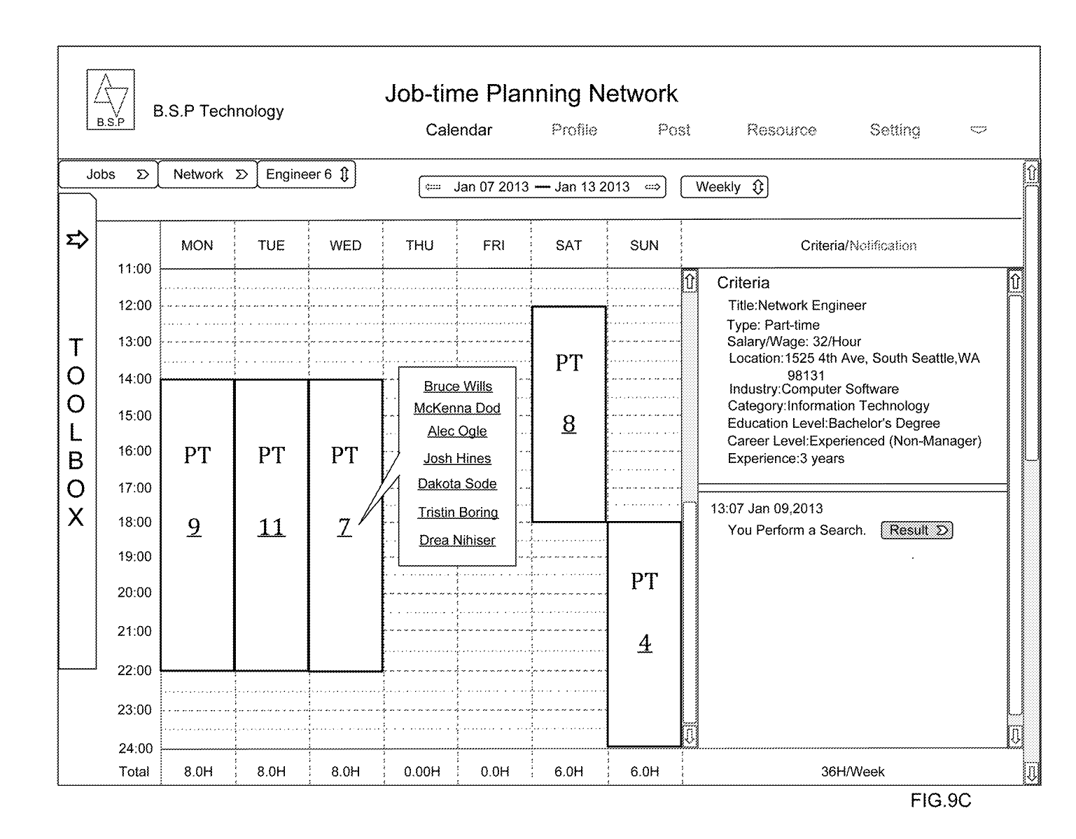

Turning now to FIGS. 9A-9C, various exemplary user interfaces according to an embodiment of the present invention are shown. In FIG. 9A, a potential employer performs a advanced search. FIG. 9B is a continuation of 9A, showing that the potential employer splits the job from 1 to 5. FIG. 9C is the search result from FIGS. 9A and 9B.

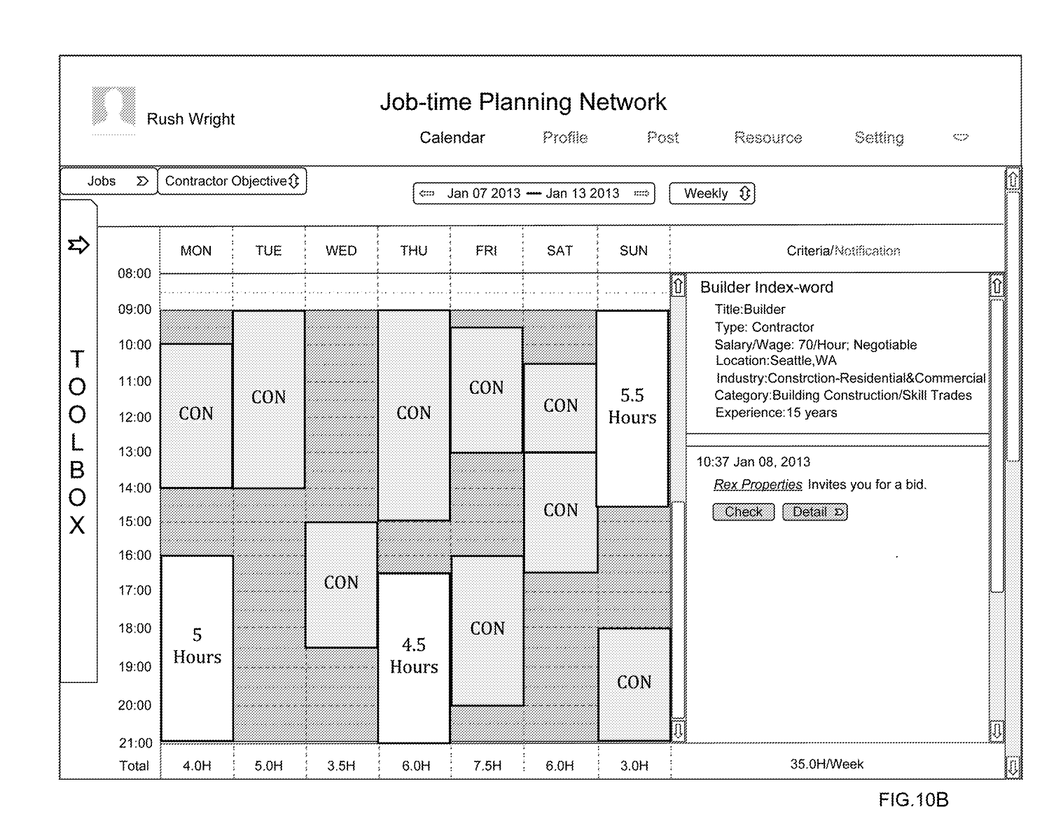

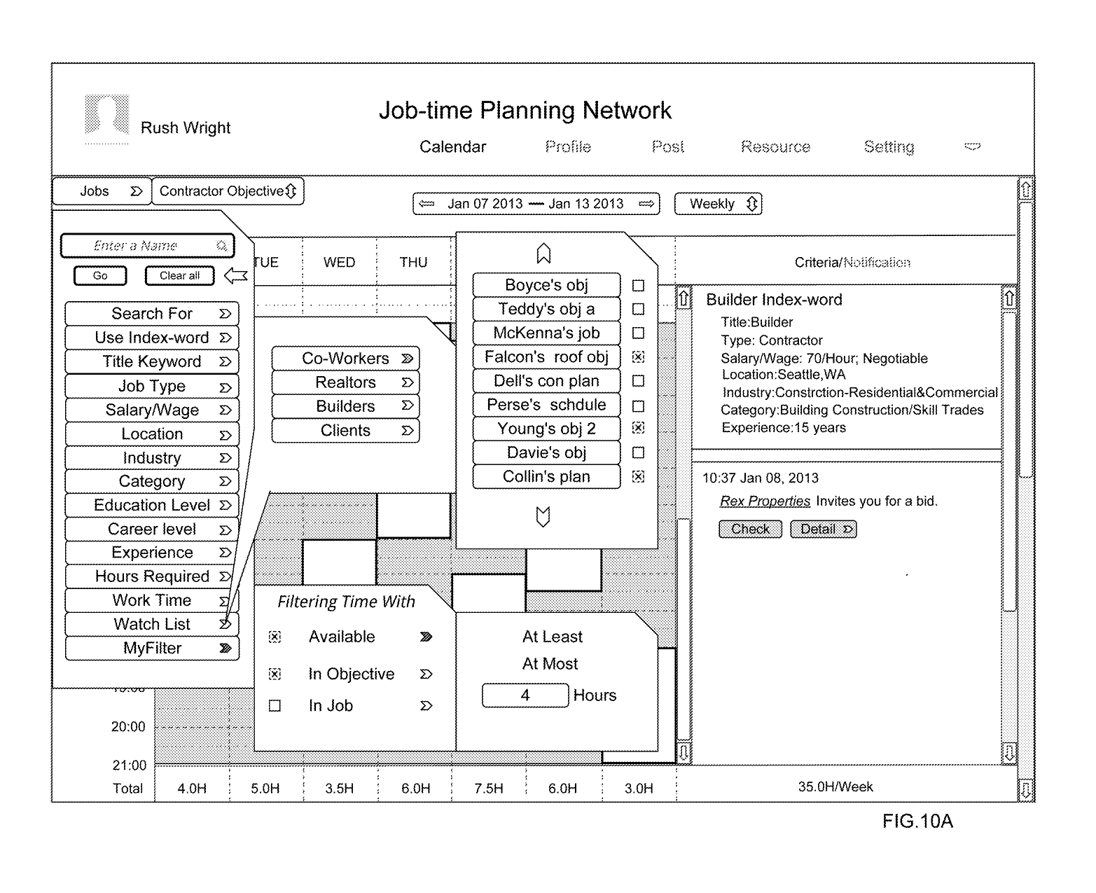

Turning now to FIGS. 10A and 10B, various exemplary user interfaces according to an embodiment of the present invention are shown. FIG. 10A shows that a contractor performs a matching among the job-time calendars among the Co-workers and FIG. 10B shows the matching results.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented system for providing job-time planning, the system comprising:
a planning management module comprising computer-executable code stored in non-volatile memory;
a search engine module comprising computer-executable code stored in non-volatile memory;
a process module comprising computer-executable code stored in non-volatile memory;
a data store;
a processor; and
a communications module,
wherein said planning management module, said search engine module, said process module, said data store, said processor, and said communications module are operably connected and are configured to:
receive a request from a first user regarding job-time planning;
identify an index-word package;
identify search criteria;
retrieve at least one index-word from an index-word database stored in said data store, wherein said at least one index-word was identified in said index-word package;
process a job-time planning search based at least in part on said at least one index-word and said search criteria; and
return results from said job-time planning search to said user via said communications module.

2. The system of claim 1, wherein said planning management module, said search engine module, said process module, said data store, said processor, and said communications module are further configured to generate a job-planning calendar from said results and return said job-planning calendar to said first user.

3. The system of claim 2, wherein said job-planning calendar comprises one or more jobs displayed on said job-planning calendar based on job-time and relevance to said first user.

4. The system of claim 1, wherein said results comprise one or more full-time jobs and criteria associated with said one or more full-time jobs.

5. The system of claim 4, wherein said planning management module, said search engine module, said process module, said data store, said processor, and said communications module are further configured to generate a set of part-time jobs based on said results.

6. The system of claim 5, wherein said set of part-time jobs is returned to said first user.

7. The system of claim 5, wherein said planning management module, said search engine module, said process module, said data store, said processor, and said communications module are further configured to generate an updated job-planning calendar based on said set of part-time jobs and return said updated job-planning calendar to said first user via said communications means.

8. A computer implemented method for providing job-time planning, the method comprising the steps of:
receiving a request from a first user regarding job-time planning via a communications module;
identifying an index-word package via a planning management module;
identifying search criteria via said planning management module;
retrieving at least one index-word from an index-word database stored in a data store, wherein said at least one index-word was identified in said index-word package;
processing, at a process module, a job-time planning search based at least in part on said at least one index-word and said search criteria; and
returning, via said communications module, results from said job-time planning search to said user.

9. The method of claim 8, further comprising the step of generating a job-planning calendar from said results and return said job-planning calendar to said first user.

10. The method of claim 9, wherein said job-planning calendar comprises one or more jobs displayed on said job-planning calendar based on job-time and relevance to said first user.

11. The method of claim 8, wherein said results comprise one or more full-time jobs and criteria associated with said one or more full-time jobs.

12. The method of claim 11, further comprising the step of generating a set of part-time jobs based on said results.

13. The method of claim 12, wherein said set of part-time jobs is returned to said first user.

14. The method of claim 12, further comprising the step of generating an updated job-planning calendar based on said set of part-time jobs and returning said updated job-planning calendar to said first user via said communications means.
